(19) United States
(12) Patent Application Publication
(10) Pub. No.: US 2022/0270266 A1
(43) Pub. Date: Aug. 25, 2022

(54) FOREGROUND IMAGE ACQUISITION METHOD, FOREGROUND IMAGE ACQUISITION APPARATUS, AND ELECTRONIC DEVICE

(71) Applicant: GUANGZHOU HUYA TECHNOLOGY CO., LTD., Guangzhou (CN)

(72) Inventors: Yiyong LI, Guangzhou (CN); Shuai HE, Guangzhou (CN); Wenlan WANG, Guangzhou (CN)

(21) Appl. No.: 17/627,964

(22) PCT Filed: Jul. 16, 2020
(86) PCT No.: PCT/CN2020/102480

§ 371 Date: May 3, 2022

(30) Foreign Application Priority Data
Jul. 19, 2019 (CN) 201910654642.6

(51) Int. Cl. G06T 7/215; G06T 7/194; G06T 7/13; G06T 3/40; G06T 5/00

(52) U.S. Cl. CPC G06T 7/215; G06T 7/194; G06T 7/13; G06T 3/40; G06T 5/002; G06T 2207/20084; G06T 2207/10016

(57) ABSTRACT

A foreground image acquisition method, a foreground image acquisition apparatus, and an electronic device. The foreground image acquisition method comprises: performing inter-frame motion detection on an acquired current video frame to obtain a first mask image; a neural network model, performing recognition on the current video frame to obtain a second mask image; and a foreground image in the current video frame and the second mask.

### CROSS-REFERENCE TO RELATED APPLICATION

The present disclosure claims priority of Chinese patent application with the filing number 2019106546426 filed on Jul. 19, 2019 with the Chinese Patent Office, and entitled “FOREGROUND IMAGE ACQUISITION METHOD, FOREGROUND IMAGE ACQUISITION APPARATUS, AND ELECTRONIC DEVICE”, the contents of which are incorporated herein by reference in entirety.

### TECHNICAL FIELD

The present disclosure relates to the technical field of image processing, and in particular, provides a foreground image acquisition method, a foreground image acquisition apparatus, and an electronic device.

### BACKGROUND ART

In some applications of image processing, foreground image extraction is required. In the above, some common foreground image extraction techniques include inter-frame difference method, background difference method, ViBe algorithm and the like. The inventors have found through researches that the above-mentioned foreground image extraction techniques are difficult to accurately and effectively perform the foreground image extraction on the video frames.

### SUMMARY

The purpose of the present disclosure is to provide a foreground image acquisition method, a foreground image acquisition apparatus, and an electronic device, so as to improve the accuracy and validity of the calculation results.

In order to realize at least one of the above-mentioned purposes, the technical solution adopted in the present disclosure is as follows.

The embodiment of the present disclosure provides a foreground image acquisition method, comprising:

performing inter-frame motion detection on an acquired current video frame to obtain a first mask image;

a neural network model performing recognition on the current video frame to obtain a second mask image;

performing calculation based on a preset calculation model, the first mask image, and the second mask image, to obtain a foreground image in the current video frame.

The embodiment of the present disclosure further provides a foreground image acquisition apparatus, comprising:

a first mask image acquisition module, configured to perform inter-frame motion detection on the acquired current video frame to obtain a first mask image;

a second mask image acquisition module, configured to perform recognition on the current video frame through a neural network model to obtain a second mask image; and

a foreground image acquisition module, configured to perform calculation according to a preset calculation model, the first mask image and the second mask image, to obtain the foreground image in the current video frame.

The embodiment of the present disclosure further provides an electronic device, comprising a memory, a processor and computer programs stored in the memory and capable of running on the processor, here, when the computer programs run on the processor, the above-mentioned foreground image acquisition method is implemented.

The embodiment of the present disclosure further provides a computer-readable storage medium on which computer programs are stored, here, when the programs are executed, the above-mentioned foreground image acquisition method is implemented.

### BRIEF DESCRIPTION OF DRAWINGS

FIG. 1 is a schematic block view of an electronic device provided by an embodiment of the present disclosure.

FIG. 2 is a schematic view of application interaction of the electronic device provided by an embodiment of the present disclosure.

FIG. 3 is a schematic flowchart view of a foreground image acquisition method provided by an embodiment of the present disclosure.

FIG. 4 is a schematic flowchart view of Step 110 in FIG. 3.

FIG. 5 is a structural block view of a neural network model provided by an embodiment of the present disclosure.

FIG. 6 is a structural block view of a second convolutional layer provided by an embodiment of the present disclosure.

FIG. 7 is a structural block view of a third convolutional layer provided by an embodiment of the present disclosure.

FIG. 8 is a structural block view of a fourth convolutional layer provided by an embodiment of the present disclosure.

FIG. 9 is a schematic flowchart view of other steps included in the foreground image acquisition method provided by an embodiment of the present disclosure.

FIG. 10 is a schematic flowchart view of Step 140 in FIG. 9.

FIG. 11 is a schematic view of the effect of calculating the area ratio provided by an embodiment of the present disclosure.

FIG. 12 is a schematic block view of functional modules included in a foreground image acquisition apparatus provided by an embodiment of the present disclosure.

Reference signs: 300—electronic device; 302—memory; 304—processor; 306—foreground image acquisition apparatus; 306a—first mask image acquisition module; 306b—second mask image acquisition module; 306c—foreground image acquisition module.

### DETAILED DESCRIPTION OF EMBODIMENTS

In order to make the objectives, technical solutions and effects of the embodiments of the present disclosure clearer, the technical solutions in the embodiments of the present disclosure will be described clearly and completely below in conjunction with drawings in the embodiments of the present disclosure. Obviously, the described embodiments are only a part of the embodiments of the present disclosure, rather than all the embodiments. The components of embodiments of the present disclosure described and illustrated in the drawings herein generally may be arranged and designed in a variety of different configurations.

Therefore, the following exemplary description of the embodiments of the present disclosure provided in the accompanying drawings is not intended to limit the claimed scope of the present disclosure, but merely represents some embodiments of the present disclosure. Based on the embodiments in the present disclosure, all other embodiments, obtained by those ordinarily skilled in the art without making inventive effort, shall fall within the protection scope of the present disclosure.

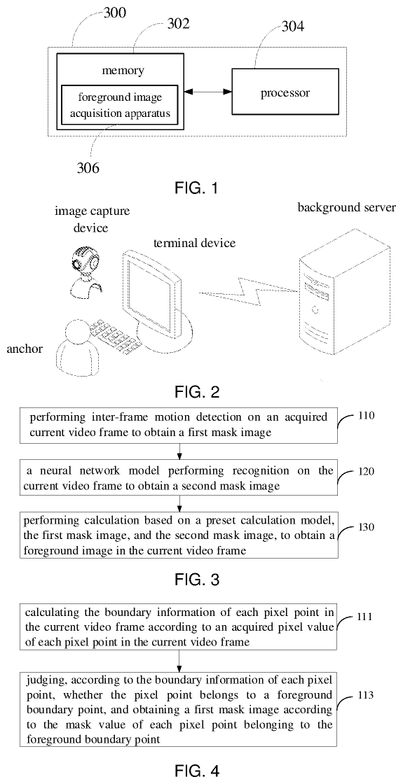

As shown in FIG. 1, an embodiment of the present disclosure provides an electronic device 300, which may comprise a memory 302, a processor 304, and a foreground image acquiring apparatus 306.

In some embodiments, the memory 302 and the processor 304 may be electrically connected with each other directly or indirectly to realize data transmission or interaction. For example, they can be electrically connected with each other through one or more communication buses or signal lines.

The foreground image acquisition apparatus 306 may include at least one software function module that may be stored in the memory 302 in the form of software or firmware. The processor 304 may be configured to execute executable computer programs stored in the memory 302, such as software function modules and computer programs included in the foreground image acquisition apparatus 306, to implement the foreground image acquisition method provided by the embodiments of the present disclosure.

In the above, the memory 302 may be, but not limited to, a random access memory (RAM), a read only memory (ROM), a programmable read-only memory (PROM), an Erasable Programmable Read-Only Memory (EPROM), and an Electric Erasable Programmable Read-Only Memory (EEPROM) and the like.

The processor 304 may be a general-purpose processor, including a central processing unit (CPU), a network processor (NP), a system on chip (SoC), and the like; may also be a digital signal processing (DSP), an application specific integrated circuit (ASIC), a field programmable gate array (FPGA) or other programmable logic devices, discrete gate or transistor logic devices, discrete hardware components.

It can be understood that the structure shown in FIG. 1 is only schematic, and the electronic device 300 may further include more or less components than those shown in FIG. 1, or have different configurations from those shown in FIG. 1, for example, the electronic device 100 may also include a communication unit configured to perform information interaction with other devices.

In the above, the present disclosure does not limit the specific type of the electronic device 300; for example, in some embodiments, the electronic device 300 may be a terminal device with better data processing performance, and for another example, in some embodiments, the electronic device 300 may also be a server.

In an alternative example, the electronic device 300 may be used as a live broadcast device, for example, may be a terminal device used by the anchor during live broadcast (live streaming), or may also be a background server that communicates with the terminal device used by the anchor during live broadcast.

When the electronic device 300 is used as a background server, as shown in FIG. 2, the image capture device may send the video frame captured and obtained by the anchor to a terminal device of the anchor, and the terminal device can send the video frame to the background server for processing.

With reference to FIG. 3, an embodiment of the present disclosure further provides a foreground image acquisition method that can be applied to the above-mentioned electronic device 300. In the above, the method steps defined by the related processes of the foreground image acquisition method may be implemented by the electronic device 300. The foreground image acquisition method provided by the present disclosure may be exemplarily described below with reference to the process steps shown in FIG. 3.

Step 110, performing inter-frame motion detection on an acquired current video frame to obtain a first mask image.

Step 120, a neural network model performing recognition on the current video frame to obtain a second mask image;

Step 130, performing calculation based on a preset calculation model, the first mask image, and the second mask image, to obtain a foreground image in the current video frame.

Through the above-mentioned method, the electronic device enables, based on the first mask image and the second mask image obtained by performing Step 110 and Step 120, increase of the calculation basis when performing Step 130 to calculate the foreground image, so as to improve the accuracy and validity of the calculation results, thereby improving the situation that it is difficult to acquire the foreground image of the video frame accurately and effectively using some other foreground extraction schemes.

The inventors of the present disclosure have found through researches that in some application scenarios (such as when acquiring video frames, if there are situations such as light flickering, lens shaking, lens zooming, and still shoot subject), compared with some other foreground image schemes, using the foreground image acquisition method provided by the embodiments of the present disclosure may have some better effects.

It should be noted that the present disclosure does not limit the sequence of execution of the above-mentioned Step 110 and Step 120, for example, in some embodiments, the electronic device may execute Step 110 first, and then execute Step 120; or, in other embodiments, the electronic device may also perform Step 120 first, and then perform Step 110; or, in other embodiments, the electronic device may also perform Step 110 and Step 120 simultaneously.

Optionally, in some embodiments, the manner in which the electronic device performs Step 110 to obtain the first mask image based on the current video frame is also not limited, and can be selected according to actual application requirements.

For example, in an alternative example, the first mask image may be obtained by calculation according to pixel value of each pixel point in the current video frame. Exemplarily, with reference to FIG. 4, Step 110 may be implemented by means of the following Steps 111 and 113:

Step 111: calculating the boundary information of each pixel point in the current video frame according to the acquired pixel value of each pixel point in the current video frame.

In some possible embodiments, after acquiring the captured current video frame by the image capture device or acquiring the forwarded current video frame by the connected terminal device, the electronic device can detect the current video frame to obtain pixel value of each pixel point. Then, based on the acquired pixel values, the boundary information of each pixel point in the current video frame is calculated; here, each piece of boundary information can characterize the pixel value level of other pixel points around the corresponding pixel point.

It should be noted that before the current video frame is detected to obtain the pixel value, the electronic device may also first convert the current video frame into a grayscale image. In an alternative example, the size of the current video frame may also be adjusted as required, for example, the size of the current video frame may be scaled to 256*256.

Step 113, judging, according to the boundary information of each pixel point, whether the pixel point belongs to the foreground boundary point, and obtaining a first mask image according to the mask value of each pixel point belonging to the foreground boundary point.

In some embodiments, after obtaining the boundary information of each pixel point in the current video frame through Step 111, the electronic device may judge according to the obtained boundary information whether each pixel point belongs to the foreground boundary point. Then, the mask values of individual pixel points belonging to the foreground boundary point are obtained, so as to obtain the first mask images based on obtained individual mask value point.

Optionally, in some embodiments, the present disclosure does not limit the manner in which the electronic device performs Step 111 to calculate the boundary information, and the manner can be selected according to actual application requirements.

For example, in an alternative example, for each pixel point, the electronic device may calculate and obtain the boundary information of the pixel point based on pixel values of multiple pixel points adjacent to the pixel point.

Exemplarily, the electronic device can calculate the boundary information of each pixel point by the following calculation formulas:

Gx=(fr_BW(i+1,j−1)+2*fr_BW(i+1,j)+fr_BW(i+1,j+1))−(fr_BW(i−1,j−1)+2*fr_BW(i−1,j)+fr_BW(i−1,j+1))

Gy=(fr_BW(i−1,j+1)+2*fr_BW(i,j+1)+fr_BW(i+1,j+1))−(fr_BW(i−1,j−1)+2*fr_BW(i,j−1)+fr_BW(i+1,j−1))

fr_gray(i,j)=sqrt(Gx\hat{ }2+Gy\hat{ }2)

in the above, fr_BW ( ) refers to the pixel value, fr_gray ( ) refers to the boundary information, Gx refers to the horizontal boundary difference, Gv refers to the longitudinal boundary difference, i refers to the i-th pixel in the horizontal direction, and j refers to the j-th pixel in the longitudinal direction.

Optionally, in some embodiments, the present disclosure does not limit the manner in which the electronic device performs Step 113 to obtain the first mask image according to the boundary information, and the manner can be selected according to actual application requirements.

For example, in an alternative example, the electronic device may compare the current video frame with the previously acquired video frame to obtain the first mask image.

Exemplarily, the electronic device may perform Step 113 through the following steps:

first, for each pixel point, the electronic device may determine the current mask value and current frequency value of the pixel point, according to the boundary information in the current video frame, the boundary information in the previous N video frames, and the boundary information in the previous M video frames of the pixel point;

then, for each pixel point, the electronic device may judge, according to the current mask value and the current frequency value, whether the pixel point belongs to the foreground boundary point, and obtain the first mask image according to the current mask value of each pixel point belonging to the foreground boundary point.

In the above, in an alternative example, the electronic device may determine the current mask value and the current frequency value of the pixel point in the following methods:

first, if the boundary information of a pixel point meets the first condition, the electronic device can update the current mask value of the pixel point to 255 and add 1 to the current frequency value. In the above, in some embodiments, the first condition may include that: the boundary information of the pixel point in the current video frame is greater than A1, and the difference value between the boundary information of the pixel point in the current video frame and the boundary information of the pixel point in the previous N video frames or the difference value between it with the boundary information of the pixel point in the previous M video frames is greater than B1;

secondly, if the boundary information of a pixel point does not meet the above-mentioned first condition, but meets the second condition, the electronic device can update the current mask value of the pixel point to 180 and add 1 to the current frequency value. In the above, in some embodiments, the second condition may include that: the boundary information of the pixel point in the current video frame is greater than A2, and the difference value between the boundary information of the pixel point in the current video frame and the boundary information of the pixel point in the previous N video frames or the difference value between it with the boundary information of the pixel point in the previous M video frames is greater than B2;

then, if the boundary information of a pixel point does not meet the above-mentioned first condition or second condition, but meets the third condition, the electronic device can update the current mask value of the pixel point to 0 and add 1 to the current frequency value. In the above, in some embodiments, the third condition may include that: the boundary information of the pixel point in the current video frame is greater than A2;

finally, for a pixel point that does not meet the first condition, the second condition or the third condition, the electronic device may update the current mask value of the pixel point to 0.

It should be noted that, in some embodiments, the above-mentioned current frequency value may refer to the number of times that a pixel point is determined to belong to the foreground boundary point in each video frame. For example, for the pixel point (i, j), if it is determined to belong to the foreground boundary point in the first video frame, the current frequency value is 1; if it is also considered to belong to the foreground boundary point in the second video frame, the current frequency value is 2; and if it is also considered to belong to the foreground boundary point in the third video frame, the current frequency value is 3.

In the above, in some embodiments, the ranges of N and M may be 1-10, and the present disclosure does not limit the specific values of N and M, as long as N is not equal to M. For example, in an alternative example, N may be 1 and M may be 3. That is, for each pixel point, the electronic device can determine the current mask value and current frequency value of the pixel point according to the boundary information of the pixel point in the current video frame, the boundary information of the pixel point in the previous video frame, and the boundary information of the pixel point in the previous three video frames.

In addition, in some embodiments, the present disclosure also does not limit the specific values of above-mentioned A1, A2, B1 and B2, for example, in an alternative example, A1 may be 30, A2 may be 20, B1 may be 12, and B2 may be 8.

In some embodiments, after obtaining the current mask value and the current frequency value of the pixel point in the above-mentioned method, the electronic device may determine the pixel point whose current mask value is greater than 0 as foreground boundary point, and determine the pixel point whose current mask value is equal to 0 as background boundary point.

Moreover, in order to improve the accuracy of determining the foreground boundary point and the background boundary point, the electronic device can also judge whether the pixel point belongs to the foreground boundary point based on the following method, and the method can include:

first, for a pixel point whose current mask value is greater than 0, if the ratio of the current frequency value of the pixel point to the current frame number is greater than 0.6, and the difference between the boundary information in the current video frame and the boundary information in the previous video frame, and the difference between it with the boundary information in the previous three video frames are both less than 10, the electronic device can re-determine the pixel point as the background boundary point;

secondly, for a pixel point whose current mask value is equal to 0, if the ratio of the current frequency value of the pixel point to the current frame number is less than 0.5, and the boundary information in the current video frame is greater than 60, the electronic device can re-determine the pixel point as the foreground boundary point, and update the current mask value of the pixel point to 180;

finally, in order to improve the accuracy of the foreground image extraction of the subsequent video frame, for the pixel point that does not meet the above-mentioned two conditions, the current frequency value of the pixel point may be reduced by 1.

Optionally, in some embodiments, the present disclosure also does not limit the manner in which the electronic device performs Step 120 to obtain the second mask image based on the current video frame, and the manner can be selected according to actual application requirements.

For example, in an alternative example, the neural network model may include multiple network sub-models for different processing, thereby obtaining the second mask image.

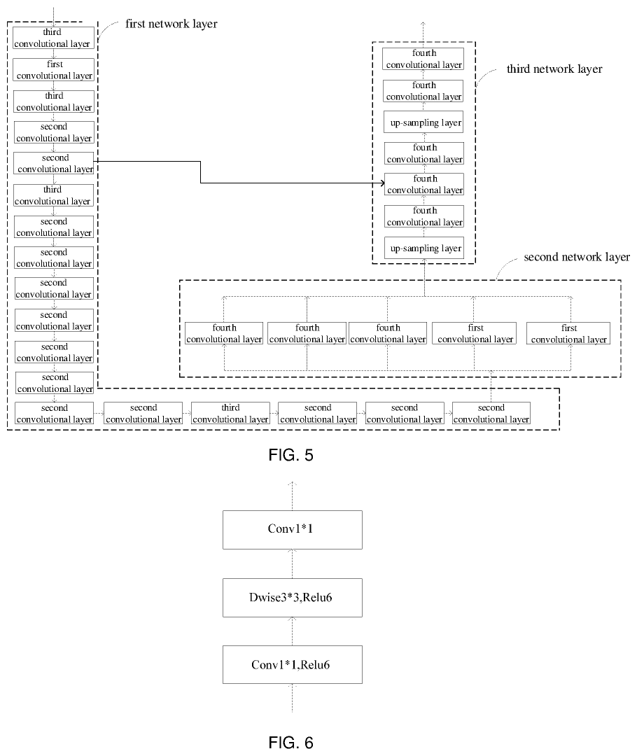

Exemplarily, with reference to FIG. 5, in a possible embodiment, the neural network model may include a first network sub-model, a second network sub-model and a third network sub-model. The electronic device may perform Step 120 through the following steps:

first, performing semantic information extraction processing on the current video frame through the first network sub-model to obtain a first output value;

secondly, performing size adjustment processing on the first output value through the second network sub-model to obtain a second output value;

then, performing a mask image extraction processing on the second output value through the third network sub-model to obtain a second mask image.

In the above, in some embodiments, the first network sub-model may be constructed by a first convolutional layer, a plurality of second convolutional layers and a plurality of third convolutional layers. The second network sub-model can be constructed by the first convolutional layer and a plurality of fourth convolutional layers. The third network sub-model can be constructed by the plurality of fourth convolutional layers and a plurality of up-sampling layers.

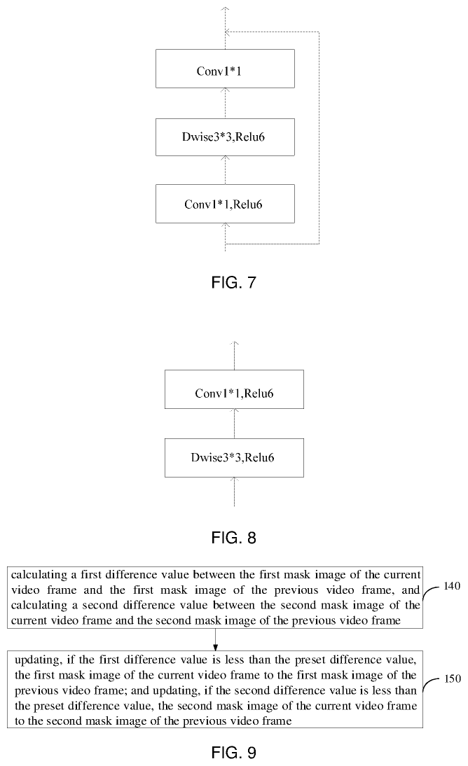

It should be noted that, in some embodiments, the first convolutional layer may be configured to perform one convolution operation (the size of the convolution kernel is 3*3). The second convolutional layers can be configured to perform two convolution operations, one depth-separable convolution operation, and two activation operations (as shown in FIG. 6). The third convolutional layers can be configured to perform two convolution operations, one depth-separable convolution operation, and two activation operations, and output the values obtained by the operations together with the input value(s) (as shown in FIG. 7). The fourth convolutional layers can be configured to perform one convolution operation, one depth-separable convolution operation, and two activation operations (as shown in FIG. 8). The up-sampling layer may be configured to perform a bilinear difference up-sampling operation (for example, an operation of up-sampling 4 times).

In the above, in order to facilitate the neural network model performing recognition processing on the current video frame, the current video frame can also be pre-scaled into an array P of 256*256*3, and then subjected to normalization processing (to obtain values belonging to −1 to 1) through the normalization calculation formula (such as (P/128)−1)), and the results obtained from the processing are input into the neural network model for recognition processing.

Optionally, as a possible embodiment, the present disclosure also does not limit the manner in which the electronic device performs Step 130 to calculate the foreground image based on a preset calculation model, and the manner can be selected according to actual application requirements.

For example, in an alternative example, the electronic device may perform Step 130 using the following steps:

first, performing weighted summation processing on the first mask image and the second mask image according to the preset first weighting coefficient and the second weighting coefficient;

then, performing summation processing on the result obtained by the weighted summation processing and a predetermined parameter to obtain the foreground image in the current video frame.

For example, as a possible embodiment, the calculation model can be expressed as follows:

M_fi=a1*M_fg+a2*M_c+b

here, a1 is the first weighting coefficient, a2 is the second weighting coefficient, b is the predetermined parameter, M_fg is the first mask image, M_c is the second mask image, and M_fi is the foreground image.

It should be noted that the above-mentioned a1, a2 and b may be determined according to a specific type of foreground image. For example, when the foreground image is a portrait, it can be obtained by collecting multiple sample portraits and performing fitting.

In addition, in some embodiments, the above-mentioned determined foreground image may be configured to perform some specific display or play controls. For example, in a live broadcast scenario, in order to avoid the occlusion of the anchor's portrait by the displayed or played barrage(s), the position of the anchor's portrait in the video frame can be first determined, and the barrage(s) can be subjected to transparent or hiding processing when the barrage(s) is/are played to this position.

That is to say, in some possible scenarios, the electronic device may also perform display or play processing on the above-mentioned foreground image. In addition, in order to avoid the situation that the portrait shakes during displaying or playing, the electronic device may also perform jitter (shaking) elimination processing.

Exemplarily, in an alternative example, with reference to FIG. 9, before the electronic device performs Step 130, the foreground image acquisition method may further include the following Steps 140 and 150.

Step 140, calculating the first difference value between the first mask image of the current video frame and the first mask image of the previous video frame, and calculating a second difference value between the second mask image of the current video frame and the second mask image of the previous video frame.

Step 150, if the first difference value is less than the preset difference value, updating the first mask image of the current video frame to the first mask image of the previous video frame; and if the second difference value is less than the preset difference value, updating the second mask image of the current video frame to the second mask image of the previous video frame.

In some embodiments, the electronic device may determine whether there is a significant change in the foreground image by calculating the amount of change of the first mask image and the second mask image between the current video frame and the previous video frame. In addition, when the electronic device determines that there is no significant change in the foreground image between two adjacent frames (the current frame and the previous frame), the electronic device can replace the foreground image of the current frame with the foreground image of the previous frame (that is, using the first mask image of the previous frame to replace the first mask image of the current frame, and using the second mask image of the previous frame to replace the second mask image of the current frame), thereby avoiding the problem of inter-frame jitter.

In this way, when the change in the foreground image (such as a portrait) is relatively small, the foreground image obtained in the current frame can be made to be same as the foreground image obtained in the previous frame, thereby achieving inter-frame stability and avoiding the problem of poor user experience caused by inter-frame jitter.

That is, in some embodiments, after the electronic device performs Step 150 to update the first mask image and the second mask image of the current video frame, when performing Step 130, the electronic device may calculate the foreground image based on the updated first mask image and second mask image.

In the above, if the first difference value is greater than or equal to the preset difference value, and the second difference value is greater than or equal to the preset difference value, it indicates that the foreground image changes greatly. In order to enable live-broadcast viewers to effectively see the actions of the anchor, when performing Step 130, the electronic device may calculate the foreground image according to the first mask image obtained by performing Step 110 and the second mask image obtained by performing Step 120, so that the foreground image is different from the foreground image of the previous frame, and the actions of the anchor are reflected when the foreground images are played.

In the above, the present disclosure does not limit the manner in which the electronic device performs Step 140 to calculate the first difference value and the second difference value, the manner and can be selected according to actual application requirements.

It is found through researches by the inventors of the present disclosure that the minor actions of the anchor are eliminated through Step 150, causing the foreground image to jump during playing.

For example, the anchor's eyes are closed in the first video frame, the anchor's eyes are open 0.1 cm in the second video frame, and the anchor's eyes are open 0.3 cm in the third video frame. Since the anchor's eyes change less from the first video frame to the second video frame, in order to avoid inter-frame jitter, the obtained foreground image of the second video frame is kept consistent with the foreground image of the first video frame, so that the eyes of the anchor in the obtained foreground image of the second video frame are also closed.

However, since the eyes of the anchor change greatly from the second video frame to the third video frame, the anchor's eyes may be opened by 0.3 cm in the obtained foreground image of the third video frame at this time. In this way, the viewer is made to see that the anchor's eyes change directly from being closed to being open by 0.3 cm, that is, there is a jump between frames (between the second frame and third frame).

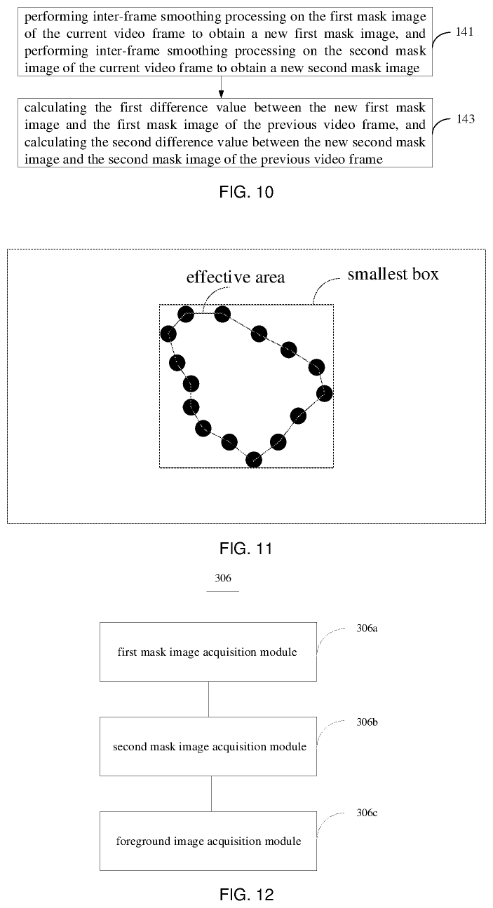

Considering that some viewers may not adapt to the above-mentioned situation of inter-frame jump, therefore, in order to avoid the situation, in an alternative example, combining with FIG. 10, the electronic device may perform Step 140 through the following Steps 141 and 143 to calculate the first difference value and the second difference value.

Step 141, performing inter-frame smoothing processing on the first mask image of the current video frame to obtain a new first mask image, and performing inter-frame smoothing processing on the second mask image of the current video frame to obtain a new second mask image;

Step 143, calculating the first difference value between the new first mask image and the first mask image of the previous video frame, and calculating the second difference value between the new second mask image and the second mask image of the previous video frame.

In some embodiments, if the first difference value is greater than or equal to a preset difference value, the electronic device may update the first mask image of the current video frame to a new first mask image, so that the electronic device can perform calculation based on the new first mask image when performing Step 150.

If the second difference value is greater than or equal to the preset difference value, the electronic device can update the second mask image of the current video frame to a new second mask image, so that the electronic device can perform calculation based on the new second mask image when performing Step 150.

In the above, the present disclosure does not limit the manner in which the electronic device performs Step 141 to perform inter-frame smoothing processing, for example, in an alternative example, the electronic device may perform Step 141 through the following steps:

first, calculating the first mean value of the first mask images of all video frames before the current video frame, and calculating the second mean value of the second mask images of all the video frames;

then, performing calculation according to the first mean value and the first mask image of the current video frame to obtain a new first mask image, and performing calculation according to the second mean value and the second mask image of the current video frame to obtain a new second mask image.

In the above, it can be understood that when the electronic device calculates the new first mask image and the new second mask image according to the first mean value and the second mean value, the present disclosure does not limit the specific calculation method.

For example, in an alternative example, the electronic device may calculate a new first mask image based on the method of weighted summation. For example, the electronic device may calculate a new first mask image according to the following formulas:

M_k₁=α1*M_k₂+β1*A_k−1

A_k−1=α2*A_k−2+β2*M_k₂−1

α1+β1=1,α2+β2=1

here, M_k1 is the new first mask image, M_k2 is the first mask image obtained through Step 110, A_k−1 is the first mean value obtained through calculation for all video frames before the current video frame, A_k−2 is the first mean value obtained through calculation for all video frames before the previous video frame, M_k2−1 is the first mask image corresponding to the previous video frame, α1 and α2 may be both preset values, and the value range of α1 may be [0.1, 0.9], the value range of α2 may be [0.125, 0.875].

It can be understood that the electronic device can also calculate the new second mask image based on the method of the weighted summation, the specific calculation formula can refer to the above-mentioned formula for calculating the new first mask image, and the present disclosure may not repeat them one by one herein.

It should be noted that, after the electronic device performs inter-frame smoothing processing through the above-mentioned method to obtain a new first mask image and a new second mask image, the electronic device may further perform binarization processing on the new first mask image and the new second mask image, and perform corresponding calculations based on results of the binarization processing in subsequent steps.

In the above, the present disclosure does not limit the manner in which the electronic device performs binarization processing, for example, in an alternative example, the electronic device may use the Otsu algorithm to perform binarization processing.

It should be noted that the present disclosure does not limit the manner in which the electronic device performs Step 143 to calculate the first difference value and the second difference value, for example, in an alternative example, the electronic device may perform Step 143 through the following steps:

first, judging whether the connected region (connected component) belongs to the first target region according to the area of each connected region in the new first mask image, and judging whether the connected region belongs to the second target region according to the area of each connected region in the new second mask image;

secondly, calculating the first barycentric coordinates of the connected regions belonging to the first target region, and updating the barycentric coordinates of the new first mask image to the first barycentric coordinates; and calculating the second barycentric coordinates of the connected regions belonging to the second target region, and updating the barycentric coordinates of the new second mask image to the second barycentric coordinates;

then, calculating the first difference value between the first barycentric coordinates and the barycentric coordinates of the first mask image of the previous video frame, and calculating a second difference value between the second barycentric coordinates and the barycentric coordinates of the second mask image of the previous video frame.

It should be noted that, in an alternative example, the electronic device may determine whether each connected region in the new first mask image belongs to the first target region, based on the following methods:

first, calculating the area of each connected region in the new first mask image, and determining the target connected region with the largest area;

secondly, judging, for each connected region in the new first mask image, whether the area of the connected region is greater than one third of the target connected region (it may also be other ratios, which can be determined according to actual application requirements);

then, determining, as the first target region, a connected region with an area greater than one third of the target connected region.

It can be understood that, the manner, in which the electronic device judges whether each connected region in the new second mask image belongs to the second target region, can refer to the above-mentioned method of judging whether each connected region in the new first mask image belongs to the first target region, the present disclosure may not repeat them one by one herein.

It should be noted that, in an alternative example, the electronic device may calculate the first barycentric coordinates of the connected regions belonging to the first target region based on the following method:

first, judging whether the quantity of connected regions belonging to the first target region is greater than a set quantity threshold (for example, the set quantity threshold may be set to 2; of course, in some other embodiments of the present disclosure, the set quantity threshold may also be other values, which can be determined according to actual application requirements);

secondly, if the quantity is greater than the set quantity threshold, calculating the first barycentric coordinates according to the barycentric coordinates of the two connected regions with the largest area belonging to the first target region; if the quantity is not greater than the set quantity threshold, calculating the first barycentric coordinates directly based on the barycentric coordinates of the connected regions belonging to the first target region.

In the above, the manner in which the electronic device calculates the second barycentric coordinates of the connected regions belonging to the second target region can refer to the above-mentioned method of calculating the first barycentric coordinates, the present disclosure may not repeat them one by one herein.

It should be noted that, after obtaining the new first mask image and the new second mask image through the calculation of the first mean value and the second mean value, the electronic device may update the first mask image obtained through Step 110 to the new first mask image, and update the second mask image obtained through Step 120 to the new second mask image.

In the above, in each of the above-mentioned steps, there is an update processing for the first mask image and the second mask image. Therefore, when the electronic device performs each step, if the update processing is performed before the step, the electronic device can perform when performing this step, processing according to the latest updated and processed first mask image and second mask image.

In addition, in some embodiments, in order to avoid waste of computing resources of the processor 304 of the electronic device 300, before the electronic device performs Step 140, region feature calculation processing may also be performed on the first mask image obtained through Step 110 and the second mask image obtained through Step 120.

In the above, the electronic device can calculate the area ratio of the effective region in the first mask image and the area ratio of the effective region in the second mask image, and determine, when the area ratio does not reach the preset ratio, that there is no foreground image in the current video frame. Therefore, the electronic device may choose not to perform subsequent steps, thereby reducing the data calculation amount of the processor 304 of the electronic device 300 and saving the computing resources of the electronic device 300.

With reference to FIG. 11, in an alternative example, the area of the connected region formed by enclosing of individual foreground boundary points may be calculated first. Secondly, connected region with the largest area is taken as the effective region. Then, the ratio of the area of the effective region to the area of the smallest box covering the effective region can be calculated to obtain the area ratio.

With reference to FIG. 12, an embodiment of the present disclosure further provides a foreground image acquisition apparatus 306, the foreground image acquisition apparatus 306 may include a first mask image acquisition module 306a, a second mask image acquisition module 306b, and a foreground image acquisition module 306c.

The first mask image acquisition module 306a is configured to perform inter-frame motion detection on the acquired current video frame to obtain a first mask image. In some embodiments, the first mask image acquisition module 306a may be configured to perform Step 110 shown in FIG. 3, the relevant content of the first mask image acquisition module 306a may refer to the foregoing description of the Step 110, the present disclosure may not repeat them one by one herein.

The second mask image acquisition module 306b is configured to perform recognition on the current video frame through a neural network model to obtain a second mask image. In some embodiments, the second mask image acquisition module 306b may be configured to perform Step 120 shown in FIG. 3, the relevant content of the second mask image acquisition module 306b may refer to the foregoing description of the Step 120, the present disclosure may not repeat them one by one herein.

The foreground image acquisition module 306c is configured to perform calculation according to a preset calculation model, the first mask image and the second mask image, to obtain the foreground image in the current video frame. In some embodiments, the foreground image acquisition module 306c may be configured to perform Step 130 shown in FIG. 3. the relevant content of the foreground image acquisition module 306c may refer to the foregoing description of the Step 130, the present disclosure may not repeat them one by one herein.

In the embodiments of the present disclosure, corresponding to the above-mentioned foreground image acquisition method, a computer-readable storage medium is further provided, the computer programs are stored in the computer-readable storage medium, and when the computer programs run, each step of the above-mentioned foreground image acquisition method is executed.

In the above, each of steps performed when the afore-mentioned computer programs run may not be repeated one by one herein and may refer to the foregoing explanation of the foreground image acquisition method provided by the present disclosure.

To sum up, the foreground image acquisition method, foreground image acquisition apparatus and electronic device provided by the present disclosure respectively perform inter-frame motion detection and neural network recognition on the same video frame, and perform calculation to obtain the foreground image in the video frame according to the obtained first mask image and the second mask image. In this way, it enables increase of the basis when calculating the foreground image, thereby improving the accuracy and validity of the calculation result, and further improving the problem that some other foreground extraction technical solutions are difficult to accurately and effectively extract the foreground image of the video frame.

The above descriptions are only some embodiments of the present disclosure, and are not intended to limit the present disclosure. For those skilled in the art, the present disclosure may have various modifications and changes. Any modification, equivalent replacement, improvement, and the like, made within the spirit and principle of the present disclosure, shall be included within the protection scope of the present disclosure.

### INDUSTRIAL APPLICABILITY

The technical solutions provided in the embodiments of the present disclosure may respectively perform inter-frame motion detection and neural network recognition on the same video frame, and perform calculation to obtain the foreground image in the video frame according to the obtained first mask image and the second mask image. In this way, the basis may be made to increase when calculating the foreground image, thereby improving the accuracy and validity of the calculation result, and further improving the problem that some other foreground extraction technical solutions are difficult to accurately and effectively extract the foreground image of the video frame.

1. A foreground image acquisition method, comprising steps of:
performing inter-frame motion detection on an acquired current video frame to obtain a first mask image;
a neural network model performing recognition on the current video frame to obtain a second mask image;
performing calculation based on a preset calculation model, the first mask image, and the second mask image, to obtain a foreground image in the current video frame.

2. The foreground image acquisition method according to claim 1, wherein the step of performing inter-frame motion detection on an acquired current video frame to obtain a first mask image comprises steps of:
calculating boundary information of each pixel point in the current video frame according to an acquired pixel value of each pixel point in the current video frame;
judging, according to the boundary information of each pixel point, whether the pixel point belongs to a foreground boundary point, and obtaining the first mask image according to a mask value of each pixel point belonging to the foreground boundary point.

3. The foreground image acquisition method according to claim 2, wherein the step of calculating boundary information of each pixel point in the current video frame according to an acquired pixel value of each pixel point in the current video frame comprises a step of:
performing calculation, for each pixel point, the boundary information of the pixel point based on pixel values of multiple pixel points adjacent to the pixel point.

4. The foreground image acquisition method according to claim 2, wherein the step of judging according to the boundary information of each pixel point whether the pixel point belongs to a foreground boundary point and obtaining the first mask image according to a mask value of each pixel point belonging to the foreground boundary point comprises steps of:
determining, for each pixel point, a current mask value and a current frequency value of the pixel point, according to the boundary information of the pixel point in the current video frame, boundary information of the pixel point in previous N video frames, and boundary information of the pixel point in previous M video frames, wherein N is not equal to M;
judging, for each pixel point, whether the pixel point belongs to the foreground boundary point, according to the current mask value and the current frequency value, and obtaining the first mask image according to the current mask value of each pixel point belonging to the foreground boundary point.

5. The foreground image acquisition method according to claim 1, wherein the neural network model comprises a first network sub-model, a second network sub-model, and a third network sub-model;
the step of the neural network model performing recognition on the current video frame to obtain a second mask image comprises steps of:
performing semantic information extraction processing on the current video frame through the first network sub-model to obtain a first output value;
performing size adjustment processing on the first output value through the second network sub-model to obtain a second output value;
performing a mask image extraction processing on the second output value through the third network sub-model to obtain a second mask image.

6. The foreground image acquisition method according to claim 5, wherein the method further comprises a step of pre-constructing the first network sub-model, the second network sub-model and the third network sub-model, the step comprises steps of:
constructing the first network sub-model through a first convolutional layer, a plurality of second convolutional layers, and a plurality of third convolutional layers, wherein the first convolutional layer is configured to perform one convolution operation, the second convolutional layers are configured to perform two convolution operations, one depth-separable convolution operation and two activation operations, and the third convolutional layers are configured to perform two convolution operation, one depth-separable convolution operation and two activation operations, and output values obtained by the operations together with input values;
constructing the second network sub-model through the first convolutional layer and a plurality of fourth convolutional layers, wherein the fourth convolutional layers are configured to perform one convolution operation, one depth-separable convolution operation and two activation operations;
constructing the third network sub-model through the plurality of fourth convolutional layers and a plurality of up-sampling layers, wherein the up-sampling layers are configured to perform a bilinear difference up-sampling operation.

7. The foreground image acquisition method according to claim 1, wherein the step of performing calculation based on a preset calculation model, the first mask image and the second mask image to obtain a foreground image in the current video frame comprises steps of:
performing weighted summation processing on the first mask image and the second mask image according to a preset first weighting coefficient and a second weighting coefficient;
performing summation processing on a result obtained by the weighted summation processing and a predetermined parameter to obtain the foreground image in the current video frame.

8. The foreground image acquisition method according to claim 1, wherein before executing the step of performing calculation based on the preset calculation model, the first mask image and the second mask image to obtain the foreground image in the current video frame, the method further comprises steps of:
calculating a first difference value between the first mask image of the current video frame and a first mask image of the previous video frame, and calculating a second difference value between the second mask image of the current video frame and a second mask image of the previous video frame;
updating, if the first difference value is less than a preset difference value, the first mask image of the current video frame to the first mask image of the previous video frame;
updating, if the second difference value is less than the preset difference value, the second mask image of the current video frame to the second mask image of the previous video frame.

9. The foreground image acquisition method according to claim 8, wherein the step of calculating a first difference value between the first mask image of the current video frame and a first mask image of the previous video frame and calculating a second difference value between the second mask image of the current video frame and a second mask image of the previous video frame comprises steps of:
performing inter-frame smoothing processing on the first mask image of the current video frame to obtain a new first mask image, and performing inter-frame smoothing processing on the second mask image of the current video frame to obtain a new second mask image;
calculating the first difference value between the new first mask image and the first mask image of the previous video frame, and calculating the second difference value between the new second mask image and the second mask image of the previous video frame;
the foreground image acquisition method further comprises steps of:
updating, if the first difference value is greater than or equal to the preset difference value, the first mask image of the current video frame to the new first mask image;
updating, if the second difference value is greater than or equal to the preset difference value, the second mask image of the current video frame to the new second mask image.

10. The foreground image acquisition method according to claim 9, wherein the step of performing inter-frame smoothing processing on the first mask image of the current video frame to obtain a new first mask image and performing inter-frame smoothing processing on the second mask image of the current video frame to obtain a new second mask image comprises steps of:
calculating a first mean value of the first mask images of all video frames before the current video frame, and calculating a second mean value of the second mask images of all the video frames;
performing calculation to obtain a new first mask image, according to the first mean value and the first mask image of the current video frame, and performing calculation to obtain a new second mask image, according to the second mean value and the second mask image of the current video frame.

11. The foreground image acquisition method according to claim 9, wherein the step of calculating the first difference value between the new first mask image and the first mask image of the previous video frame, and calculating the second difference value between the new second mask image and the second mask image of the previous video frame comprises steps of:
judging whether a connected region belongs to a first target region according to an area of each connected region in the new first mask image, and judging whether the connected region belongs to a second target region according to an area of each connected region in the new second mask image;
calculating first barycentric coordinates of the connected regions belonging to the first target region, and updating barycentric coordinates of the new first mask image to the first barycentric coordinates;
calculating second barycentric coordinates of the connected regions belonging to the second target region, and updating barycentric coordinates of the new second mask image to the second barycentric coordinates;
calculating a first difference value between the first barycentric coordinates and barycentric coordinates of the first mask image of the previous video frame, and calculating a second difference value between the second barycentric coordinates and barycentric coordinates of the second mask image of the previous video frame.

12. The foreground image acquisition method according to claim 11, wherein the step of judging whether a connected region belongs to a first target region according to an area of each connected region in the new first mask image comprises:
calculating an area of each connected region in the new first mask image, and determining a target connected region with a largest area;
judging, for each connected region in the new first mask image, whether an area of the connected region is greater than one third of the target connected region;
determining, as the first target region, a connected region with an area greater than one third of the target connected region.

13. The foreground image acquisition method according to claim 11, wherein the step of calculating first barycentric coordinates of the connected regions belonging to the first target region comprises:
judging whether a quantity of the connected regions belonging to the first target region is greater than a set quantity threshold;
calculating, if the quantity is greater than the set quantity threshold, the first barycentric coordinates according to barycentric coordinates of two connected regions with the largest area belonging to the first target region;
calculating, if the quantity is not greater than the set quantity threshold, the first barycentric coordinates based on the barycentric coordinates of the connected regions belonging to the first target region.

14. (canceled)

15. An electronic device, comprising a memory, a processor and computer programs stored in the memory and capable of running on the processor, wherein when the computer programs run on the processor, the foreground image acquisition method according to claim 1 is implemented.

16. A computer-readable storage medium on which computer programs are stored, wherein when the programs are executed, the foreground image acquisition method according to claim 1 is implemented.

17. The foreground image acquisition method according to claim 2, wherein before executing the step of performing calculation based on the preset calculation model, the first mask image and the second mask image to obtain the foreground image in the current video frame, the method further comprises steps of:
calculating a first difference value between the first mask image of the current video frame and a first mask image of the previous video frame, and calculating a second difference value between the second mask image of the current video frame and a second mask image of the previous video frame;
updating, if the first difference value is less than a preset difference value, the first mask image of the current video frame to the first mask image of the previous video frame;
updating, if the second difference value is less than the preset difference value, the second mask image of the current video frame to the second mask image of the previous video frame.

18. The foreground image acquisition method according to claim 3, wherein before executing the step of performing calculation based on the preset calculation model, the first mask image and the second mask image to obtain the foreground image in the current video frame, the method further comprises steps of:
calculating a first difference value between the first mask image of the current video frame and a first mask image of the previous video frame, and calculating a second difference value between the second mask image of the current video frame and a second mask image of the previous video frame;
updating, if the first difference value is less than a preset difference value, the first mask image of the current video frame to the first mask image of the previous video frame;
updating, if the second difference value is less than the preset difference value, the second mask image of the current video frame to the second mask image of the previous video frame.

19. The foreground image acquisition method according to claim 4, wherein before executing the step of performing calculation based on the preset calculation model, the first mask image and the second mask image to obtain the foreground image in the current video frame, the method further comprises steps of:
calculating a first difference value between the first mask image of the current video frame and a first mask image of the previous video frame, and calculating a second difference value between the second mask image of the current video frame and a second mask image of the previous video frame;
updating, if the first difference value is less than a preset difference value, the first mask image of the current video frame to the first mask image of the previous video frame;
updating, if the second difference value is less than the preset difference value, the second mask image of the current video frame to the second mask image of the previous video frame.

20. The foreground image acquisition method according to claim 5, wherein before executing the step of performing calculation based on the preset calculation model, the first mask image and the second mask image to obtain the foreground image in the current video frame, the method further comprises steps of:
calculating a first difference value between the first mask image of the current video frame and a first mask image of the previous video frame, and calculating a second difference value between the second mask image of the current video frame and a second mask image of the previous video frame;
updating, if the first difference value is less than a preset difference value, the first mask image of the current video frame to the first mask image of the previous video frame;
updating, if the second difference value is less than the preset difference value, the second mask image of the current video frame to the second mask image of the previous video frame.

21. The foreground image acquisition method according to claim 7, wherein before executing the step of performing calculation based on the preset calculation model, the first mask image and the second mask image to obtain the foreground image in the current video frame, the method further comprises steps of:
calculating a first difference value between the first mask image of the current video frame and a first mask image of the previous video frame, and calculating a second difference value between the second mask image of the current video frame and a second mask image of the previous video frame;
updating, if the first difference value is less than a preset difference value, the first mask image of the current video frame to the first mask image of the previous video frame;
updating, if the second difference value is less than the preset difference value, the second mask image of the current video frame to the second mask image of the previous video frame.
